(19) United States
(12) Patent Application Publication
(10) Pub. No.: US 2013/0079459 A1
(43) Pub. Date: Mar. 28, 2013

(54) BLENDS OF POLYETHERIMIDE SULFONE AND POLY(ARYLENE SULFIDE) AND METHODS OF MAKING

(71) Applicants: Hariharan Ramalingam, Bangalore (IN); Gurulingamurthy M. Haralur, Evansville, IN (US); Siva Kumar Sreeramagiri, Bangalore (IN); Gautam Chatterjee, Bangalore (IN); Kapil Chandrakant Sheth, Evansville, IN (US); Sanjay Braj Mishra, Evansville, IN (US)

(72) Inventors: Hariharan Ramalingam, Bangalore (IN); Gurulingamurthy M. Haralur, Evansville, IN (US); Siva Kumar Sreeramagiri, Bangalore (IN); Gautam Chatterjee, Bangalore (IN); Kapil Chandrakant Sheth, Evansville, IN (US); Sanjay Braj Mishra, Evansville, IN (US)

(73) Assignee: SABIC INNOVATIVE PLASTICS IP B.V., Bergen op Zoom (NL)

(21) Appl. No.: 13/246,581

(22) Filed: Sep. 27, 2011

(51) Int. Cl. C08L 81/06; C08K 7/14; C08L 79/08; C08K 3/40

(52) U.S. Cl. 524/538; 525/420; 525/430

(57) ABSTRACT

A composition comprising a compatible blend of i) 15 to 45 wt % of a linear poly (arylene sulfide), ii) 50 to 85 wt % of a polyetherimide sulfone; and iii) 1 to 3 wt % of a novolac resin having an average of 2 or more epoxy groups per molecule. The composition can comprise a polyetherimide. An article made from the composition has a property selected from the group of (i) tensile strength greater than or equal to 90 megaPascals (MPa), as determined by ASTM D638, (ii) an impact strength of greater than or equal to 3 kiloJoules per square meter (kJ/m²), as determined by ASTM D256, (iii) an elongation at break greater than or equal to 3% as determined by ASTM D638, (iv) a heat distortion temperature greater than or equal to 160° C. as determined by ASTM D648, and combinations of two or more of the foregoing properties.

### BACKGROUND

There has long been an interest in developing thermoplastic amorphous semi-crystalline blends that exhibit good mechanical retention at high temperature and resistance to chemicals. Many polymer blends exhibiting crystalline properties are know in the art. However, these polymer blends generally tend to be incompatible with other polymers.

Poly(arylene sulfide)s have good thermal stability and chemical resistance. Polyetherimide sulfones exhibit good retention of mechanicals at high temperature. It would be desirable to combine the two polymers to create a blend having a combination of these desirable properties. However, polyetherimide sulfones are incompatible with poly(arylene sulfide)s. Blends of the two polymers tend to have poor physical properties which are consistent with large regions (domains) of the individual polymers instead of fine, well-dispersed domains.

Accordingly, a need exists for compatible blends poly(arylene sulfide)s and polyetherimide sulfones.

### BRIEF DESCRIPTION

The foregoing need is addressed, at least in part, by a composition comprising a compatible blend of i) 15 to 45 weight percent of a linear poly(arylene sulfide), ii) 50 to 85 weight percent of a polyetherimide sulfone, and iii) 1 to 3 weight percent of a novolac resin having an average of 2 or more epoxy groups per molecule. Weight percent is based on the total weight of the composition. The composition can further comprise 15 to 35 weight percent of a polyetherimide, based on the total weight of the composition. An article made from the composition has a property selected from the group of (i) a tensile strength greater than or equal to 90 megaPascals (MPa), as determined by ASTM D638, (ii) an impact strength of greater than or equal to 3 kiloJoules per square meter (kJ/m²), as determined by ASTM D256, (iii) a heat deflection temperature that is greater than 160 degrees C. as determined by ASTM D648 at 1.82 megaPascals (MPa), (iv) an elongation at break greater than or equal to 3% as determined by ASTM D638, and combinations of two or more of the foregoing properties.

Also disclosed herein is a method of making a polyetherimide sulfone/linear poly(arylene sulfide) composition comprising melt mixing polyetherimide and polyetherimide sulfone to form an initial composition, melt mixing the initial composition with linear poly(arylene sulfide), and a novolac resin having an average of 2 or more epoxy groups per molecule.

### DETAILED DESCRIPTION

It was found that compositions comprising a linear poly(arylene sulfide), polyetherimide sulfone, and an novolac resin having 2 or more epoxy groups per molecule have improved physical properties compared to similar compositions without the epoxy containing compound. An article made from the composition has a property selected from the group of (i) a tensile strength greater than or equal to 90 MPa, as determined by ASTM D638, (ii) an impact strength of greater than or equal to 3 KJ/m², as determined by ASTM D256, (iii) a heat deflection temperature greater than 160 degrees C. as determined by ASTM D648, (iv) an elongation at break greater than or equal to 3% as determined by ASTM D638, and combinations of two or more of the foregoing properties. This combination of physical properties is not obtained using branched poly(arylene sulfide) in place of the linear poly(arylene sulfide). This combination of properties is also not obtained using alternate polymeric compatibilizers in place of the novolac resin. Furthermore, this combination of properties is not obtained using less of the novolac resin.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

The polyetherimide sulfone comprises structural units derived from a dianhydride and a diamine. Exemplary dianhydrides have the formula (I)

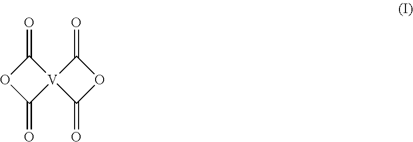

wherein V is a tetravalent linker selected from the group consisting of substituted or unsubstituted, saturated, unsaturated or aromatic monocyclic and polycyclic groups having 5 to 50 carbon atoms, substituted or unsubstituted alkyl groups having 1 to 30 carbon atoms, substituted or unsubstituted alkenyl groups having 2 to 30 carbon atoms and combinations comprising at least one of the foregoing linkers. Suitable substitutions and/or linkers include, but are not limited to, carbocyclic groups, aryl groups, ethers, sulfones, sulfides amides, esters, and combinations comprising at least one of the foregoing. Exemplary linkers include, but are not limited to, tetravalent aromatic radicals of formula (II), such as:

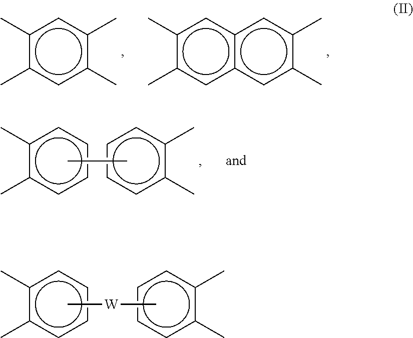

wherein W is a divalent moiety such as —O—, —S—, —C(O)—, —SO2-, —SO—, —CyH2y- (y being an integer of 1 to 20), and halogenated derivatives thereof, including perfluoroalkylene groups, or a group of the formula —O—Z—O— wherein the divalent bonds of the —O— or the —O—Z—O— group are in the 3,3′, 3,4′, 4,3′, or the 4,4′ positions, and wherein Z includes, but is not limited to, divalent moieties of formula (III)

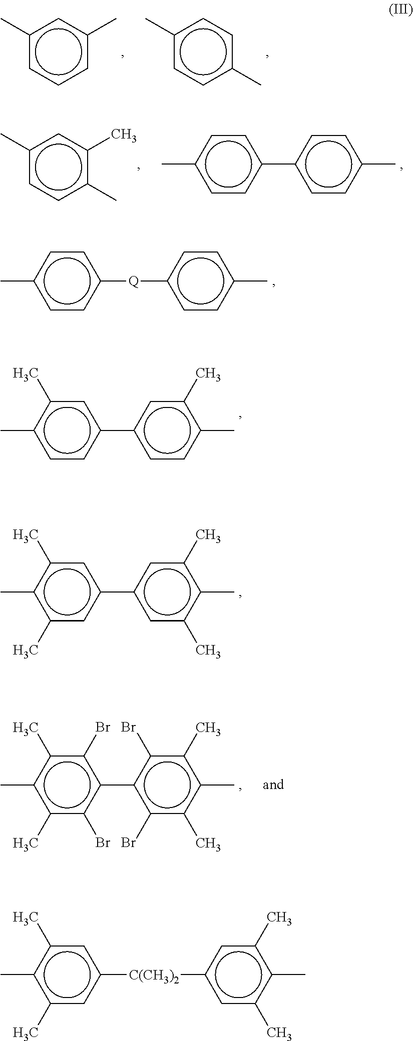

wherein Q includes, but is not limited to, a divalent moiety comprising —O—, —S—, —C(O)—, —SO₂—, —SO—, —C_{y}H₂— (y being an integer from 1 to 20), and halogenated derivatives thereof, including perfluoroalkylene groups. In some embodiments the tetravalent linker V is free of halogens.

In one embodiment, the dianhydride comprises an aromatic bis(ether anhydride). Examples of specific aromatic bis(ether anhydride)s are disclosed, for example, in U.S. Pat. Nos. 3,972,902 and 4,455,410, incorporated herein their entirety. Illustrative examples of aromatic bis(ether anhydride)s include: 2,2-bis[4-(3,4-dicarboxyphenoxy)phenyl]propane dianhydride (bisphenol-A dianhydride); 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as mixtures comprising at least two of the foregoing.

The bis(ether anhydride)s can be prepared by the hydrolysis, followed by dehydration, of the reaction product of a nitro substituted phenyl dinitrile with a metal salt of dihydric phenol compound in the presence of a dipolar, aprotic solvent.

A chemical equivalent to a dianhydride may also be used. Examples of dianhydride chemical equivalents include tetra-functional carboxylic acids capable of forming a dianhydride and ester or partial ester derivatives of the tetra functional carboxylic acids. Mixed anhydride acids or anhydride esters may also be used as an equivalent to the dianhydride. As used throughout the specification and claims “dianhydride” will refer to dianhydrides and their chemical equivalents.

In some embodiments the dianhydride is selected from the groups consisting of bisphenol-A dianhydride, oxydiphthalic anhydride (ODPA), and combinations thereof. Oxydiphthalic anhydride has the general formula (IV):

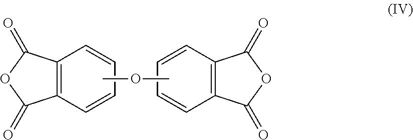

and derivatives thereof as further defined below.

The oxydiphthalic anhydrides of formula (IV) include 4,4′-oxybisphthalic anhydride, 3,4′-oxybisphthalic anhydride, 3,3′-oxybisphthalic anhydride, and any mixtures thereof. For example, the oxydiphthalic anhydride of formula (IV) may be 4,4′-oxybisphthalic anhydride having the following formula (V):

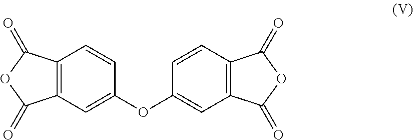 [SMILES: O=C1OC(=O)c2cc(Oc3ccc4c(c3)C(=O)OC4=O)ccc21]

The term oxydiphthalic anhydrides includes derivatives of oxydiphthalic anhydrides which may also be used to make the polyimide. Examples of oxydiphthalic anhydride derivatives which can function as a chemical equivalent for the oxydiphthalic anhydride in polyimide forming reactions include oxydiphthalic anhydride derivatives of the formula (VI):

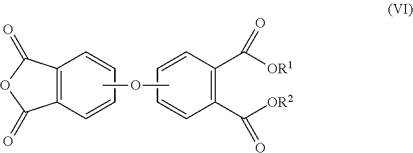

wherein R¹ and R² of formula VIII can be, independently at each occurrence, any of the following: hydrogen; a C₁-C₈ alkyl group; an aryl group. R¹ and R² can be the same or different to produce an oxydiphthalic anhydride acid, an oxydiphthalic anhydride ester, and an oxydiphthalic anhydride acid ester.

Derivatives of oxydiphthalic anhydrides may also be of the following formula (IX):

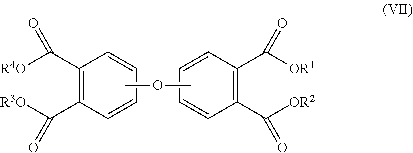

wherein R¹, R², R³, and R⁴ of formula (VII) can be, independently at each occurrence, any of the following: hydrogen, a C₁-C₈ alkyl group, an aryl group. R¹, R², R³, and R⁴ can be the same or different to produce an oxydiphthalic acid, an oxydiphthalic ester, and an oxydiphthalic acid ester.

Useful diamines include diamino diaryl sulfones and combinations thereof. Diamino diaryl sulfones (DAS) have the general formula (X):

H₂N—Ar¹—SO₂—Ar²—NH₂ (X)

wherein Ar¹ and Ar² independently are an aryl group containing a single or multiple rings. Several aryl rings may be linked together, for example, through ether linkages, sulfone linkages or more than one sulfone linkage. The aryl rings may also be fused. In one embodiment Ar¹ and Ar² independently comprise 5 to 12 carbons. In one embodiment Ar¹ and Ar² are both phenyl groups.

In some embodiments the polyetherimide sulfone comprises structural units having the formula (XI)

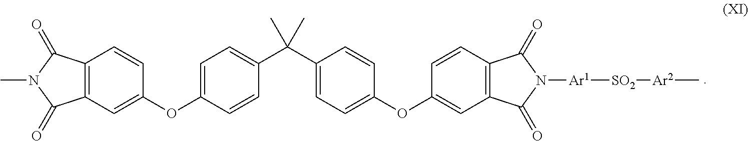

In some embodiments the polyetherimide sulfone comprises structural units having the formula (XII)

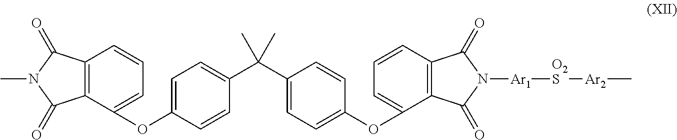

The polyetherimide sulfone may be present in an amount of 50 to 85 weight percent, based on the total weight of the composition. Within this range the amount of polyetherimide sulfone can be greater than or equal to 52 weight percent. Also within this range the amount of polyetherimide sulfone can be less than or equal to 80 weight percent.

Poly(arylene sulfide)s are known polymers containing arylene groups separated by sulfur atoms. They include poly(phenylene sulfide)s, for example poly(phenylene sulfide) and substituted poly(phenylene sulfide)s. Typical poly(arylene sulfide) polymers comprise at least 70 molar %, preferably at least 90 molar %, of recurring units of the following structural formula:

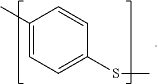

The poly(arylene sulfide) is a linear polymer. Linear poly(arylene sulfide) may be prepared by, for example, a process disclosed in U.S. Pat. Nos. 3,354,129 or 3,919,177 both of which are incorporated herein by reference. Linear poly(arylene sulfide) is commercially available from Ticona as Fortron® PPS and from Chevron Phillips as Ryton® PPS.

The poly(arylene sulfide) may be functionalized or unfunctionalized. If the poly(arylene sulfide) is functionalized, the functional groups may include, but are not limited to, amino, carboxylic acid, metal carboxylate, disulfide, thio, and metal thiolate groups. One method for incorporation of functional groups into poly(arylene sulfide) can be found in U.S. Pat. No. 4,769,424, incorporated herein by reference, which discloses incorporation of substituted thiophenols into halogen substituted poly(arylene sulfide). Another method involves incorporation of chlorosubstituted aromatic compounds containing the desired functionality reacted with an alkali metal sulfide and chloroaromatic compounds. A third method involves reaction of poly(arylene sulfide) with a disulfide containing the desired functional groups, typically in the melt or in a suitable high boiling solvent such as chloronaphthalene.

Though the melt viscosity of poly(arylene sulfide) is not particularly limited so far as the moldings which can be obtained, the melt viscosity can be greater than or equal to 100 Poise and less than of equal to 10,000 poise at the melt processing (300 to 350° C.).

The poly(arylene sulfide) may also be treated to remove contaminating ions by immersing the resin in deionized water or by treatment with an acid, typically hydrochloric acid, sulfuric acid, phosphoric acid or acetic acid as found in Japanese Kokai Nos. 3236930-A, 1774562-A, 12299872-A, and 3236931-A. For some product applications, it is preferred to have a very low impurity level in the poly(arylene sulfide), represented as the percent by weight ash remaining after burning a sample of the poly(arylene sulfide). The ash content of the poly(arylene sulfide) can be less than about 1% by weight, more specifically less than about 0.5% by weight, or even more specifically less than about 0.1% by weight.

The poly(arylene sulfide) is present in an amount of 15 to 45 weight percent, based on the total weight of the composition. Within this range the amount of poly(arylene sulfide) can be greater than or equal to 20 weight percent. Also within this range the amount of poly(arylene ether) can be less than or equal to 40 weight percent.

The novolac resin has an average of greater than or equal to 2 pendant epoxy groups per molecule. In some embodiments the novolac has an average of greater than or equal to 6 pendant epoxy groups per molecule, or, more specifically, an average of greater than or equal to 20 pendant epoxy groups per molecule or, more specifically, an average of greater than or equal to 50 pendant epoxy groups per molecule. Without being bound by theory it is believed that the novolac resin interacts with the linear poly(arylene sulfide), the polyetherimide sulfone, or both. This interaction may be chemical (e.g. grafting) and/or physical (e.g. affecting the surface characteristics of the disperse phases). When the interaction is chemical, the epoxy groups of the novolac resin may be partially or completely reacted with the linear poly(arylene sulfide), the polyetherimide sulfone, or both such that the composition comprises a reaction product.

The novolac resin is made by reacting a phenol with formaldehyde. The term “phenol” as used herein includes phenyl, aryl, and fused aromatic rings having a hydroxyl group. The molar ratio of formaldehyde to phenol is less than 1. The novolac resin is functionalized with epoxy groups by reacting the novolac resin with epichlorohydrin in the presence of sodium hydroxide as a catalyst. The novolac resin can have an average molecular weight of 500 to 2500 Daltons. Within this range the novolac resin can have a molecular weight greater than or equal to 550 Daltons. Also within this range the novolac resin can have a molecular weight less than or equal to 900 Daltons.

The composition comprises 1 weight percent to 3 weight percent of novolac resin, based on the total weight of the composition. Within this range, the composition can comprise less than or equal to 2.5 weight percent, or, more specifically less than or equal to 2 weight percent.

The composition may further comprise a polyetherimide. The polyetherimide is different from the polyetherimide sulfone. Polyetherimides comprise repeating structural units derived from a dianhydride and a diamine other than a diamino diaryl sulfone. Polyetherimides are commercially available from SABIC Innovative Plastics.

When present the polyetherimide may be used in an amount of 15 to 35 weight percent, based on the total weight of the composition. Within this range the amount of polyetherimide can be greater than or equal to 20 weight percent. Also within this range the amount of polyetherimide can be less than or equal to 30 weight percent, or, more specifically, less than or equal to 25 weight percent.

The composition may further comprise an additive or combination of additives. Exemplary additives include electrically conductive fillers, reinforcing fillers, stabilizers, lubricants, mold release agents, inorganic pigments, UV absorbers, antioxidants, plasticizers, anti-static agents, foaming agents, blowing agents, metal deactivators, and combinations comprising one or more of the foregoing. Examples of electrically conductive fillers include conductive carbon black, carbon fibers, metal fibers, metal powder, carbon nanotubes, and the like, and combinations comprising any one of the foregoing electrically conductive fillers. Examples of reinforcing fillers include glass beads (hollow and/or solid), glass flake, milled glass, glass fibers, talc, wollastonite, silica, mica, kaolin or montmorillonite clay, silica, quartz, barite, and the like, and combinations comprising any of the foregoing reinforcing fillers. Antioxidants can be compounds such as phosphites, phosphonites, and hindered phenols or mixtures thereof Phosphorus containing stabilizers including triaryl phosphite and aryl phosphonates are of note as useful additives. Difunctional phosphorus containing compounds can also be employed. Stabilizers may have a molecular weight greater than or equal to 300. In some embodiments, phosphorus containing stabilizers with a molecular weight greater than or equal to 500 are useful. Phosphorus containing stabilizers are typically present in the composition at 0.05-0.5% by weight of the formulation. Flow aids and mold release compounds are also contemplated.

The thermoplastic composition can be prepared melt mixing or a combination of dry blending and melt mixing. Melt mixing can be performed in single or twin screw type extruders or similar mixing devices which can apply a shear and heat to the components. Melt mixing can be performed at temperatures greater than or equal to the melting temperatures of the block copolymers and less than the degradation temperatures of either of the block copolymers.

All of the ingredients may be added initially to the processing system. In some embodiments, the ingredients may be added sequentially and/or through the use of one or more master batches. It can be advantageous to apply a vacuum to the melt through one or more vent ports in the extruder to remove volatile impurities in the composition.

In some embodiments the method of making the composition comprises melt mixing the polyetherimide and the polyetherimide sulfone to form an initial composition which can be pelletized prior to melt mixing the initial composition with the linear poly(arylene sulfide) and polymeric compatibilizer.

In some embodiments melt mixing is performed using an extruder and the composition exits the extruder in a strand or multiple strands. The shape of the strand is dependent upon the shape of the die used and has no particular limitation.

The invention is further illustrated by the following non-limiting examples.

### EXAMPLES

The examples described below used the materials shown in Table 1.

TABLE 1

| Material | Description | Source |
|---|---|---|
| Polyetherimide sulfone | EXTEM ® XH 1005 | SABIC Innova- |
| | | tive Plastics |
| Polyetherimide sulfone | EXTEM ® VH 1003 | SABIC Innova- |
| | | tive Plastics |
| Polyetherimide | ULTEM ® | SABIC Innova- |
| | | tive Plastics |
| Linear poly(phenylene | Fortron ® 0214B | Ticona |
| sulfide) | | |
| Branched poly(phenylene | Ryton ® P4 | Chevron Phillips |
| sulfide) | | |
| Branched poly(phenylene | Susteel ® PPS 040 | TOSOH |
| sulfide) | | Corporation |
| Branched poly(phenylene | Susteel ® PPS 040 | TOSOH |
| sulfide) | | Corporation |
| Polymeric compound having | Joncryl ® ADR4368 | BASF |
| an average of 24 pendant | | |
| epoxy per molecule | | |
| Polymeric compound having | Bondfast E | Sumitomo |
| an average of 17 pendant | | |
| epoxy per molecule | | |
| Epoxy cresol novolac resin | Poly(o-cresyl | Aldrich |
| (ECN) | glycidyl ether)- | |
| | co-formaldehyde | |

### Techniques & Procedures

Composition Preparation Techniques: Resin compositions were formed by melt mixing the polyetherimide sulfone and poly(phenylene sulfide)s. Blends were prepared by extrusion in a 2.5-inch twin screw, vacuum vented extruder. Compositions are listed in weight percent, based on the total weight of the composition in the tables below. The extruder was set at about 300-350° C. The blends were run at approximately 250 rotations per minute (rpm) under vacuum. The extrudate was cooled, pelletized, and dried at 125° C. Test samples were injection molded at a set temperature of 340-350° C. and mold temperature of 125° C. using a 30 second cycle time.

Properties Testing: Properties were measured using ASTM test methods. All molded samples were conditioned for at least 48 hours at 50% relative humidity prior to testing.

ASTM D256: Notched Izod impact values were measured at room temperature on 3.2 millimeter thick bars as per ASTM D256. Bars were notched prior to oven aging; samples were tested at room temperature. Results are in kilojoules per square meter (KJ/m²).

ASTM D638: Tensile properties were measured on 3.2 millimeter type I bars as per ASTM method D638 at 23 ° C. with a crosshead speed of 5 millimeters/minute. Tensile strength is reported at yield (Y), percent elongation (% Elong.) is reported at break (B). Tensile modulus, tensile strength at yield, tensile strength at break results are reported in MPa.

ASTM D648: Heat Deflection Temperature (HDT) were measured on 3.2 millimeter injection molded bar at 1.82 Mpa Stress. HDT is reported in degree Celsius (C).

### Examples 1-8

The purpose of these Examples was to demonstrate the effect of linear poly(arylene sulfide) and branched poly(arylene sulfide) in the presence and absence of the novolac resin. Compositions were made in accordance to the composition preparation procedure described above. The compositions were tested as described above and results are shown in Table 2.

TABLE 2

| | 1 | 2* | 3* | 4* | 5* | 6* | 7* | 8* |
|---|---|---|---|---|---|---|---|---|
| EXTEM XH1005 | 70 | 70 | 70 | 70 | 70 | 70 | 70 | 70 |
| Fortron 0214B | 30 | 30 | | | | | | |
| Susteel PPS 040 | | | | | | | 30 | 30 |
| Susteel PPS 070 | | | 30 | 30 | | | | |
| Ryton P4 | | | | | 30 | 30 | | |
| ECN | 1 | | | 1 | | 1 | | 1 |
| Tensile Strength | 90 | 70 | 74 | 78 | 78 | 77 | 71 | 73 |
| Tensile Modulus | 3107 | 3252 | 3170 | 3165 | 3268 | 3273 | 3201 | 3183 |
| % Elongation @ | 3 | 3 | 3 | 3 | 3 | 3 | 3 | 3 |
| break | | | | | | | | |
| Impact strength | 4.5 | 2.5 | 3.0 | 3.5 | — | — | 2.6 | 2.8 |
| HDT | 204 | 203 | 195 | 194 | 197 | 200 | 190 | 195 |

*Comparative Examples

Examples 1-8 show that compositions having a branched poly(arylene sulfide) do not show the same improvement in physical properties in the presence of the novolac resin as compositions comprising a linear poly(arylene sulfide). A comparison of Examples 1 and 2 shows that in compositions comprising a linear poly(arylene sulfide) there is a marked increase in tensile strength, elongation at break and impact strength in the presence of a novolac resin. Examples 3-8 show that this improvement is not seen in examples comprising a branched poly(arylene sulfide). None of the compositions in Examples 3-8 have a combination of a tensile strength greater than or equal to 90 MPa, an impact strength of greater than or equal to 3 kJ/m², and an elongation at break greater than or equal to 3%.

### Examples 9-15

The purpose of these Examples was to demonstrate the effect of differing amounts and types of polymeric compatibilizer in compositions having the polyetherimide sulfone as the major resin. Compositions were made in accordance to the composition preparation procedure described above. The compositions were tested as described above and results are shown in Table 3.

TABLE 3

| | 9 | 10* | 11* | 12* | 13* | 14* | 15* |
|---|---|---|---|---|---|---|---|
| EXTEM XH1005 | 70 | 70 | 70 | 70 | 70 | 70 | 70 |
| Fortron 0214B | 30 | 30 | 30 | 30 | 30 | 30 | 30 |
| ECN | 1 | | 0.5 | | | | |
| Joncryl ADR 4368 | | | | 0.5 | 1 | | |
| Bond Fast E | | | | | | 0.5 | 1 |
| Tensile Strength | 90 | 70 | 79 | 80 | 82 | 75 | 77 |
| Tensile Modulus | 3107 | 3252 | 3160 | 3125 | 3166 | 3077 | 2953 |
| % Elongation @ | 3 | 3 | 3 | 3 | 3 | 3 | 3 |
| break | | | | | | | |
| Impact strength | 4.5 | 2.5 | 3 | 3.9 | 4.1 | 2.9 | 3.1 |
| HDT | 204 | 203 | 204 | 205 | 204 | 204 | 202 |

*Comparative Example

These examples demonstrate that only by using a novolac resin in the required amount yields a composition capable of achieving a combination of a tensile strength greater than or equal to 90 MPa, an impact strength of greater than or equal to 3 kJ/m², and an elongation at break greater than or equal to 3%.

### Examples 16-19

The purpose of these Examples was to demonstrate the effect of the process used to make the composition on the final physical properties of the composition. Compositions were made in a one pass method (in accordance to the composition preparation procedure described above) or a two pass method in which the polyetherimide sulfone and polyetherimide were melt mixed at 350 to 360 degrees C. to form an initial mixture and then the initial mixture was melt mixed with the poly(arylene sulfide) and novolac resin at 330 to 340 degrees C. The compositions were tested as described above and results are shown in Table 4.

TABLE 4

| | 16 | 17* | 18* | 19 |
|---|---|---|---|---|
| | Two Pass | Two Pass | One Pass | One Pass |
| EXTEM XH1005 | 52.5 | 52.5 | 52.5 | 52.5 |
| ULTEM | 22.5 | 22.5 | 22.5 | 22.5 |
| Fortron 0214B | 25 | 25 | 25 | 25 |
| ECN | 1 | | | 1 |
| Tensile Strength | 102 | 99 | 88 | 92 |
| Tensile Modulus | 3236 | 3328 | 3247 | 3552 |
| % Elongation at break | 15 | 7 | 4 | 5 |
| Impact strength | 4.5 | 4.0 | 3.2 | 3.6 |
| HDT | 200 | 199 | 198 | 198 |

*Comparative Example

Compositions made with the two pass method showed a greater increase in tensile strength, elongation at break, and impact strength than compositions made with the one pass method.

### Examples 20-28

The purpose of these Examples was to demonstrate the effect of differing amounts polyetherimide. Compositions were made in accordance with the two pass method described above. For compositions not containing the novolac resin, (ECN), only the poly(arylene sulfide) was added to the initial mixture. The compositions were tested as described above and results are shown in Table 5.

TABLE 5

| | 20 | 21* | 22 | 23* | 24 | 25* | 26 | 27* | 28* |
|---|---|---|---|---|---|---|---|---|---|
| EXTEM | 52.5 | 60 | 60 | 52.5 | 52.5 | 50 | 50 | 42 | 42 |
| XH1005 | | | | | | | | | |
| Fortron 0214B | 25 | 25 | 25 | 25 | 25 | 30 | 30 | 40 | 40 |
| Ultem | 22.5 | 15 | 15 | 22.5 | 22.5 | 20 | 20 | 18 | 18 |
| ECN | 1 | | 1 | | 1 | | 1 | | 1 |
| Tensile Strength | 102 | 91 | 99 | 99 | 102 | 88 | 92 | 85 | 89 |
| Tensile | 3236 | 3034 | 3110 | 3328 | 3236 | 3247 | 3552 | 3177 | 3321 |
| Modulus | | | | | | | | | |
| % Elongation at | 15 | 5 | 8 | 7 | 15 | 4 | 5 | 5 | 5 |
| break | | | | | | | | | |
| Impact Strength | 4.5 | 3.7 | 4.2 | 4.0 | 4.5 | 3.0 | 3.1 | 3.0 | 3.4 |
| HDT | 200 | 211 | 209 | 199 | 200 | 190 | 192 | 191 | 191 |

*Comparative example

These results show that with increasing amounts of polyetherimide the compositions still achieve the desired levels of tensile strength, impact strength, and elongation.

### Examples 29-30

The purpose of these Examples was to further demonstrate the effect the novolac resin. Compositions were made using the one pass method described above. The compositions were tested as described above and results are shown in Table 9.

TABLE 9

| | 29 | 30* |
|---|---|---|
| EXTEM VH 1003 | 75 | 75 |
| Fortron 0214B | 25 | 25 |
| ECN | 1 | |
| Tensile Strength | 90 | 87 |
| Tensile Modulus | 3192 | 3283 |
| % Elongation at break | 48 | 39 |
| Impact Strength | 8.7 | 6.9 |
| HDT | 202 | 199 |

*Comparative Example

Polyetherimide sulfones and poly(arylene sulfide)s are immiscible and show excellent compatibility when combined with a novolac resin having an average of at least two epoxy groups per molecule. The blends exhibit excellent processibility with improved tensile and impact performance.

All ASTM tests were performed as required by the 2003 edition of the Annual Book of ASTM Standards unless otherwise indicated. All notched and unnotched Izod data and values were/are determined according to ASTM D256 at 23° C. as described in the Examples section unless another temperature has been specified. All tensile modulus, tensile strength, and elongation to break data and values were/are determined according to ASTM D638 as described in the Examples section.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composition comprising a compatible blend of i) 15 to 45 weight percent of a linear poly (arylene sulfide), ii) 50 to 85 weight percent of a polyetherimide sulfone and (iii) 1 to 3 weight percent of a novolac resin having an average of 2 or more epoxy groups per molecule,
wherein weight percent is based on the total weight of the composition, and an article made from the composition has a property selected from the group of (i) a tensile strength greater than or equal to 90 megaPascals (MPa), as determined by ASTM D638, (ii) an impact strength of greater than or equal to 3 kiloJoules per square meter (kJ/m²), as determined by ASTM D256, (iii) an elongation at break greater than or equal to 3% as determined by ASTM D638, (iv) a heat deflection temperature that is greater than 160 C as determined by ASTM D648, and combinations of two or more of the foregoing properties.

2. The composition of claim 1, wherein the poly(arylene sulfide) is poly(phenylene sulfide).

3. The composition of claim 1, wherein the polyetherimide sulfone comprises structural units having the formula 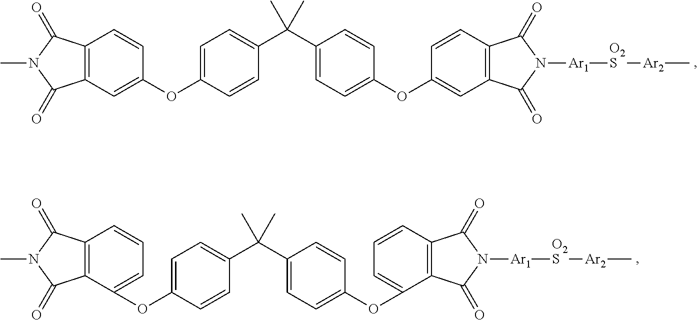
or a combination of the preceding formulas.

4. The composition of claim 1, wherein the novolac resin has an average of 6 or more epoxy groups per molecule.

5. The composition of claim 1, wherein the novolac resin has an average of 20 or more epoxy groups per molecule.

6. The composition of claim 1, further comprising 15 to 35 weight percent of a polyetherimide, based on the total weight of the composition.

7. The composition of claim 1, further comprising a reinforcing filler.

8. The composition of claim 8, wherein the reinforcing filler comprises glass beads, glass flake, milled glass, glass fibers, and combinations comprising any of the foregoing.

9. A composition comprising the reaction product of melt blending i) 15 to 45 weight percent of a linear poly (arylene sulfide), ii) 50 to 85 weight percent of a polyetherimide sulfone; and iii) 1 to 3 weight percent of a novolac resin having an average of 2 or more epoxy groups per molecule, wherein weight percent is based on the total weight of the composition, and an article made from the composition has a property selected from the group of (i) tensile strength greater than or equal to 70 megaPascals (MPa), as determined by ASTM D638, (ii) an impact strength of greater than or equal to 3 kiloJoules per square meter (kJ/m²), as determined by ASTM D256, (iii) an elongation at break greater than or equal to 3% as determined by ASTM D638, (iv) a heat deflection temperature that is greater than 160 C as determined by ASTM D648, and combinations of two or more of the foregoing properties.

10. The composition of claim 9, wherein the linear poly(arylene sulfide) is linear poly(phenylene sulfide).

11. The composition of claim 9, wherein the polyetherimide sulfone comprises structural units having the formula 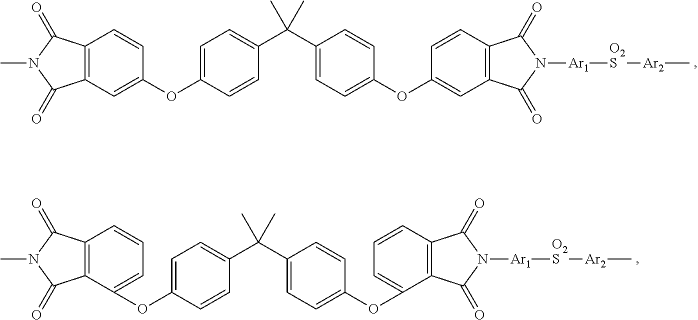
or a combination thereof.

12. The composition of claim 9, wherein the novolac resin has an average of 6 or more epoxy groups per molecule.

13. The composition of claim 9, wherein the novolac resin has an average of 20 or more epoxy groups per molecule.

14. The composition of claim 9, further comprising 15 to 35 weight percent of a polyetherimide, based on the total weight of the composition.

15. A method of making a polyetherimide sulfone/linear poly(arylene sulfide) composition comprising melt mixing polyetherimide and polyetherimide sulfone to form an initial composition and melt mixing the initial composition with linear poly(arylene sulfide) and a novolac resin having an average of 2 or more epoxy groups per molecule.

16. The method of claim 15, wherein the linear poly(arylene sulfide) is linear poly(phenylene sulfide).

17. The method of claim 15, wherein the linear poly(arylene sulfide) is present in an amount of 15 to 45 weight percent, the polyetherimide sulfone is present in an amount of 50 to 85 weight percent, the polyetherimide is present in an amount of 15 to 35 weight percent, and the novolac resin is present in an amount of 1 to 3 weight percent, based on the total weight of the composition.

18. The method of claim 15, wherein the poly(arylene sulfide) is poly(phenylene sulfide).

19. The method of claim 15, wherein the polyetherimide sulfone comprises structural units having the formula 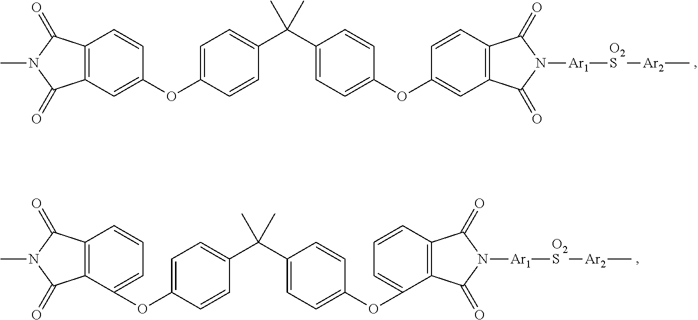
or a combination thereof.

20. The method of claim 15, wherein the novolac resin has an average of 6 or more epoxy groups per molecule.

21. The method of claim 15, wherein the novolac resin has an average of 20 or more epoxy groups per molecule.
